(19) United States
(12) Patent Application Publication
(10) Pub. No.: US 2022/0235727 A1
(43) Pub. Date: Jul. 28, 2022

(54) ROTATING DETONATION ENGINE

(71) Applicant: Physical Sciences, Inc., Andover, MA (US)

(72) Inventors: Jeffrey L. Wegener, Nashua, NH (US); Christopher T. Farrell, Medford, MA (US)

(21) Appl. No.: 17/582,408

(22) Filed: Jan. 24, 2022

Related U.S. Application Data
(60) Provisional application No. 63/141,542, filed on Jan. 26, 2021.

(51) Int. Cl. F02K 9/66

(52) U.S. Cl. CPC F02K 9/66

(57) ABSTRACT

A rotating detonation engine includes an outer body with an opening therethrough having an interior wall and an inner body received in the outer body opening and with an outer wall tapering in the flow direction of the engine and spaced from the outer body opening interior wall defining a non-cylindrical improved efficiency detonation channel between the inner body outer wall and outer body opening interior wall.

### RELATED APPLICATIONS

This application claims benefit of and priority to U.S. Provisional Application Ser. No. 63/141,542 filed Jan. 26, 2021, under 35 U.S.C. §§ 119, 120, 363, 365, and 37 C.F.R. § 1.55 and § 1.78, which is incorporated herein by this reference.

### GOVERNMENT RIGHTS

This invention was made with U.S. Government support under Contract No. FA9300-19-P-1010 awarded by the U.S. Air Force. The Government may have certain rights in the subject invention.

### FIELD OF THE INVENTION

This invention relates to the field of combustion and propulsion whereby rotating detonation engines are used to produce energy or thrust.

### BACKGROUND OF THE INVENTION

Rotating detonation engines burn reactants using detonation combustion rather than deflagration combustion. Detonation processes represent a more efficient thermodynamic cycle than deflagration processes, giving rotating detonation engines the potential to exceed the efficiencies of conventional combustion devices in rocket engines and air-breathing engines.

A typical rotating detonation engine works by flowing reactants into a straight cylindrical combustion channel at sufficiently high flow rates to cause a detonation to form after ignition occurs. The detonation travels circularly around the channel, consuming reactants that are injected ahead of the continuous wave. Rather than exiting the channel, the detonation wave continues to travel around the channel as fresh reactants flow into the upstream end of the channel. Exhaust products created by the combustion process exit the combustor at high velocity to produce thrust as in a rocket engine, ramjet engine, or gas turbine augmenter, or to drive a turbine as in a gas turbine engine.

A geometric area contraction, i.e., throat, may or may not be located at the downstream end of the channel. A geometric expansion. i.e., exhaust nozzle, may or may not be located downstream of the channel and throat, if employed. In conventional thrust-producing combustion devices, such as rocket engines and ramjets, this reduction and subsequent expansion in flow area is used to accelerate high temperature exhaust gases with the goal of maximizing thrust for a given mass flow rate of propellant(s). However, cylindrical rotating detonation engines have failed to achieve thrust efficiencies that exceed those of deflagration combustion devices currently in use.

Some designs have resulted in thrust efficiencies, defined as the specific impulse, that do not reach those of deflagration devices. Instead, these designs may result in a) shock reflections at the throat, whereby shock waves emitting from detonation waves are redirected and decelerated by sudden restrictions in the cross-sectional area of the annulus, b) abrupt turning of supersonic exhaust gases, whereby hot gases exhausted from the detonation channel, or throat restriction if present, are turned inward or outward in order to transition to the exhaust nozzle geometry being employed, and c) for a combustor surface area consisting of the inner wall of the combustor, the outer wall of the combustor, and the exhaust nozzle wall(s) that removes an undesirably large amount of energy from the combustion process due to wall heat transfer.

A cone shaped plug nozzle has been demonstrated to increase the specific impulse above that which is possible with a flat, abrupt exit plane. However, adding a conical, hyperbolic, or other curve that converges the nozzle to a smaller diameter, requires that the exhaust gases turn inward at the end of the straight cylindrical section. A geometry is desired that properly expands the high-speed exhaust gases without abrupt turns or bends in the flow path.

Theoretically, the thermodynamic efficiency of detonation processes is greater than 10% more efficient than deflagration processes, but in practice, studies have failed to demonstrate this improvement as a net performance benefit for rotating detonation engines.

Relevant prior art includes U.S. Pat. No. 4,741,154; Stechniann, D. P. (2017). Experimental study of high-pressure rotating detonation combustion in rocket environments (Doctoral dissertation, Purdue University) (see page 57); and Paxson, D. E. (2020), Preliminary Computational Assessment of Disk Rotating Detonation Engine Configurations, AIAA Scitech 2020 Forum (p. 2157), all incorporated herein by this reference.

### BRIEF SUMMARY OF THE INVENTION

The problem of operating a rotating detonation engine where continuously rotating detonations traveling around a straight cylindrical detonation channel produce thrust inefficiently is solved, in one example, by using a cone-shaped detonation channel rather than a cylindrical detonation channel, eliminating the cylindrical section of the channel and drawing the walls towards the axial centerline of the engine.

By designing and operating a cylindrical rotating detonation engine and a conical rotating detonation engine, exploratory work demonstrated that, for a given mass flow rate of propellants, the engine's thrust was increased when the cylindrical geometry was replaced with a conical geometry. This thrust performance benefit was demonstrated by firing a rotating detonation engine with 80 to 200 lbf of thrust using oxygen as the oxidizer and methane as the fuel.

Disclosed herein is a novel geometric design for a rotating detonation engine. The geometric design includes an injection region which directs reactants into a detonation channel region, and both regions are angled with respect to the centerline axis of the engine. The detonation channel is not cylindrically shaped. The detonation channel has a variable inner diameter and a variable outer diameter, producing an inward oriented channel. The wall surfaces of the channel are preferably smoothly integrated with the expansion nozzle to produce a gentle or unnoticeable transition from one to the other. At the upstream proximal end of the detonation channel, reactants are injected inward with an angle of orientation that nominally matches the angle of orientation of the detonation channel. In order to preserve the momentum of gases and maximize thrust, abrupt turns in the flow path are preferably avoided. Flow begins with an inward orientation implemented by the injector(s), and gases are allowed to smoothly turn outward, not inward, in order to produce axially straight flow during the expansion process.

A conical rotating detonation engine described herein improves detonation stability in configurations with an area restriction by eliminating the need for an abrupt constriction, i.e., throat; improves thrust efficiency by reducing flow turns and better preserving momentum of exhaust gases; improves combustion efficiency by positioning a concave wall, rather than a flat perpendicular wall, along the path of the detonation wave and associated shock wave; reduces the total heat loss of the engine by reducing the internal surface area of the combustor; and improves the ease of implementation by reducing the total wall surface that must be cooled during operation.

Featured is a rotating detonation engine detonation channel with a cross-sectional area that decreases along the streamwise direction, increases along the streamwise direction, or remains constant along the streamwise direction. In some embodiments, the outer wall of the combustion channel may terminate while continuing the inner wall along the streamwise direction, extending the inner body of the engine beyond the outer body of the engine. The inner wall of the channel may converge to a tip or a flat truncated end. The inner wall of the channel may have a straight conical shape or a curved conical shape. In any embodiment an oxidizer such as air, oxygen, dinitrogen tetroxide, or other liquid or gaseous oxidizer that detonates when mixed with the fuel may be used. Hydrocarbon-based fuel, hydrazine-based fuel, hydrogen, or other liquid or gaseous fuel that detonates when mixed with the oxidizer may be used.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

Featured is a rotating detonation engine comprising: an outer body with an opening therethrough having an interior wall, an inner body received in the outer body opening and with an outer wall tapering in the flow direction of the engine and spaced from the outer body opening interior wall defining a non-cylindrical improved efficiency detonation channel between the inner body outer wall and outer body opening interior wall, and means for retaining the inner body within the outer body.

The inner body outer wall may taper from a larger proximal upstream perimeter to a smaller distal downstream perimeter. The inner body outer wall may form a cone. The outer body opening interior wall preferably tapers. The outer body opening interior wall may expand from a smaller proximal upstream perimeter to a larger distal downstream perimeter. Or, the outer body opening interior wall may taper from a larger proximal upstream perimeter to a smaller distal downstream perimeter.

In one example, the detonation channel has a constant width along the flow direction. In another version, the detonation channel has a variable width along the flow direction. The detonation channel may have a cross sectional area that decreases along the streamwise direction, increases along the streamwise direction, or remains constant along the streamwise direction.

The engine may further include an injector configured to mix an oxidizer and fuel and to direct the mixture into the detonation channel. The injector can be configured to direct the mixture at an angle corresponding to the angle of the detonation channel. The means for retaining may include at least one fastener coupling the inner body to an injector structure and one or more fasteners coupling the outer body to an injector structure. The inner body distal downstream end can be fitted with a cone structure. In one example, the cone structure has a truncated, flat end. The injector can include an inner injection flange including outer peripheral fuel injector holes. The engine may include an outer injection flange receiving the inner injection flange therein and including inner peripheral oxidizer injection holes. The outer fuel injection holes and the inner oxidizer injection holes can be configured to mix a fuel and an oxidizer at the proximal upstream region of the detonation channel and to direct the mixture into and along the direction of the channel.

Also featured is a rotating detonation engine comprising: an outer body with an opening therethrough having an interior wall and an inner body received in the outer body opening and with an outer wall tapering in the flow direction of the engine and spaced from the outer body opening interior wall defining a non-cylindrical improved efficiency detonation channel between the inner body outer wall and outer body opening interior wall. An injector assembly includes peripheral fuel injector slot or holes and peripheral oxidizer injector slot or holes configured to mix a fuel and an oxidizer and to direct the mixture into and along the direction of the detonation channel. The inner body and the outer body are secured to the injector assembly to space the outer body opening interior wall from the inner body outer wall.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a view of a prior art rotating detonation engine with reactants injected on the left and hot exhaust products exiting with supersonic velocity on the right;

FIG. 2 is a schematic view of a new rotating detonation engine outer body and three versions of an inner body;

FIG. 3 is a view of an example of complete rotating detonation engine;

FIG. 4 is an exploded view showing the individual components of FIG. 3;

FIG. 5 is another exploded side view of the engine of FIG. 3;

FIGS. 6-8 are schematic views showing different versions of the rotating detonation engine outer body interior wall and inner body exterior wall;

FIGS. 9-11 are schematic views showing three different possible cone half angles for the inner body;

FIG. 12 is a schematic view showing how an oxidizer and a fuel are mixed and injected in a streamwise direction along the detonation channel;

FIG. 13 is a schematic view of another injector arrangement;

FIG. 14 is a schematic view showing the addition of a divergent bell nozzle to the rotating detonation engine;

FIG. 15 is a schematic view showing a conical rotating detonation engine and additional details of the injector components;

FIGS. 16-17 show a conical rotating detonation engine with a cone attached to the inner body to extend the inner body to a point;

FIG. 18 is a view of an area restriction created by the conical detonation channel;

FIG. 19 is a plot of thrust versus mass flow rate comparing three conical rotating detonation engines (configurations 2-4) with a cylindrical detonation chamber design (configuration 1);

FIG. 20 is plot of specific impulse versus mass flow rate for the same four configurations;

FIG. 21 is a plot of capillary tube attenuated pressure (CTAP) measurements versus mass flow rate for the same four configurations; and

FIGS. 22-34 are additional views of examples of engine components.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings, if only one embodiment is described herein, the claims hereof are not to be limited to that embodiment. Moreover, the claims hereof are not to be read restrictively unless there is clear and convincing evidence manifesting a certain exclusion, restriction, or disclaimer.

In some embodiments, a detonation channel is formed that is not parallel with the axial centerline of the engine, creating a cone-shaped annulus rather than a cylinder-shaped annulus. The engine may employ fuel and oxidizer injector(s) at an angle corresponding to the angle of the cone-shaped annulus, such that reactants are directed at an angle that nominally matches the angle of orientation of the annulus.

The detonation channel may have a cross-sectional area that decreases along the streamwise direction, increases along the streamwise direction, or remains constant. Included are designs with increasing channel area and decreasing channel area. The channel width may decrease along the streamwise direction, increase along the streamwise direction, or remain constant. Included are rotating detonation engine designs with increasing channel width and constant channel width.

The angle of orientation of the detonation channel may be any angle between 0° and 90°, where 0° represents a conventional cylindrical channel and 90° represents a disk-shaped channel.

In all cases of the cone-shaped annulus embodied here, the inner and outer walls of the channel may take on any curved shaped necessary to gradually turn the flow to be more parallel with the axial centerline of the engine. Included is a cone half-angle of 45′ followed by a contoured turn to make the flow more parallel with the axial centerline.

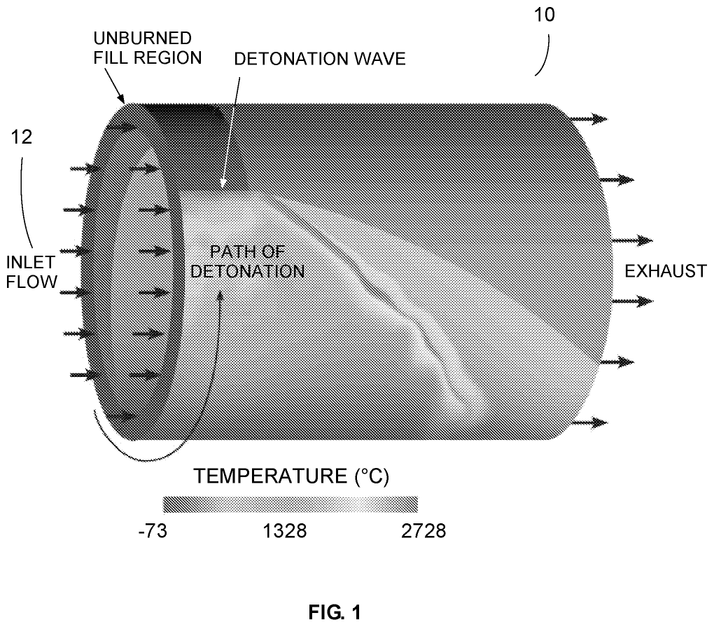

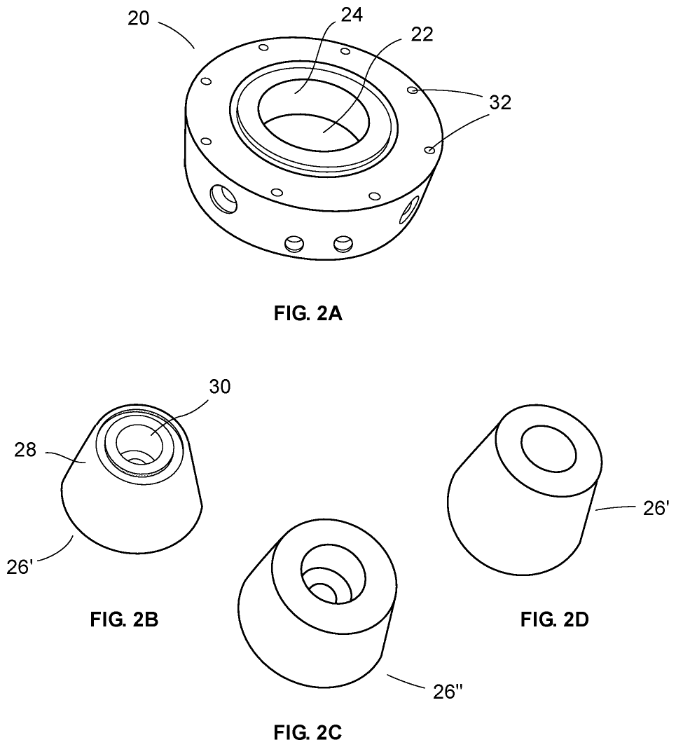

FIG. 1 depicts a prior art rotating detonation engine 10 showing the fuel/oxidizer inlet flow 12 and the path of detonation, FIG. 2 shows an example of a rotating detonation engine outer body 20 with an opening 22 therethrough having interior wall 24. Three examples of an inner body 26′, 26″, and 26′″ are also shown. Each has an outer wall 28 tapering in the flow direction of the engine. Here, each cone-shaped inner body has a central opening 30 for a fastener (e.g., a bolt) coupled to the inner body and to another structure such as an injector plenum. Outer body 20 includes fastener holes 32 for fixing outer body 20 to another structure such as an injector face.

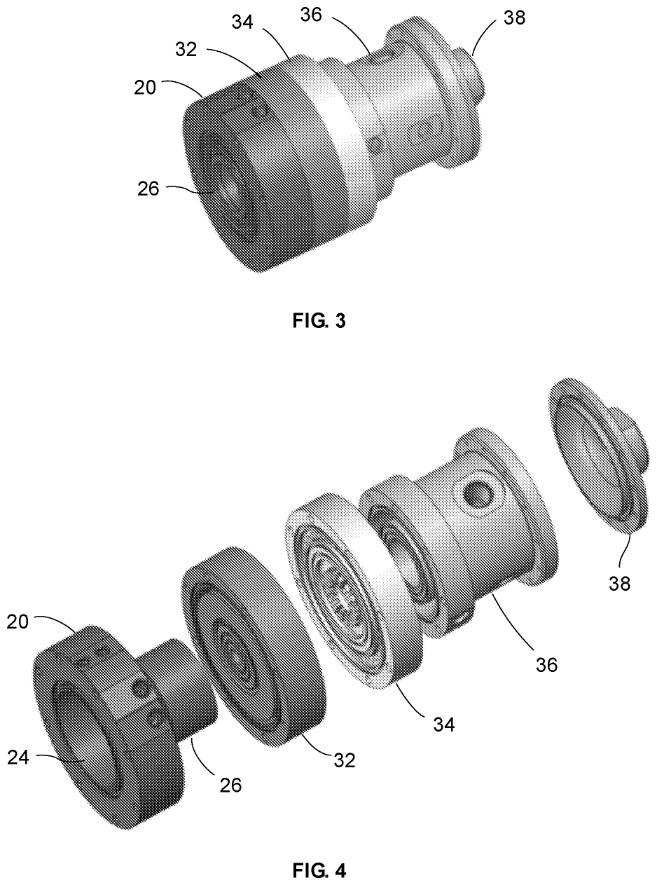

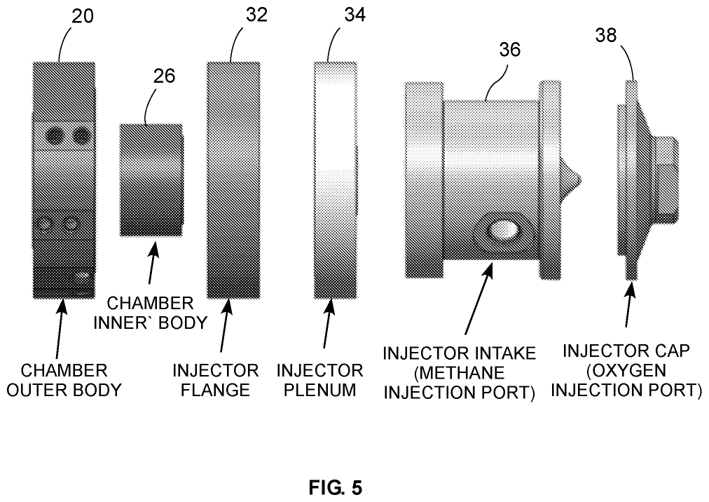

FIGS. 3-5 show a complete engine including an inner body 26 received in outer body 20, an injector flange 32, an injector plenum 34, an injector intake 36, and an end flange 38.

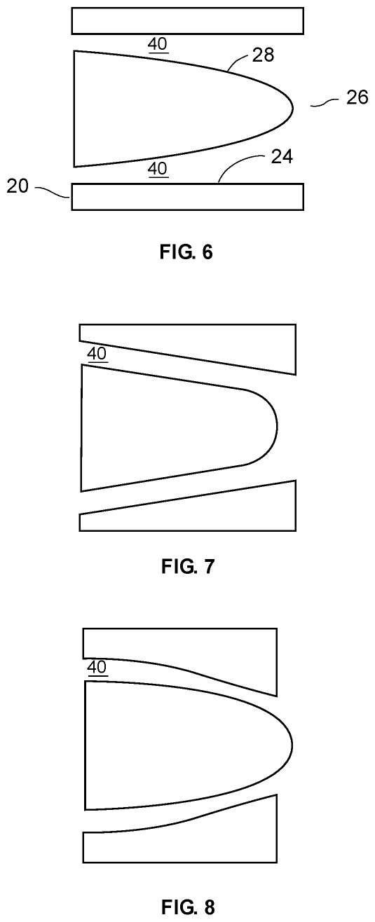

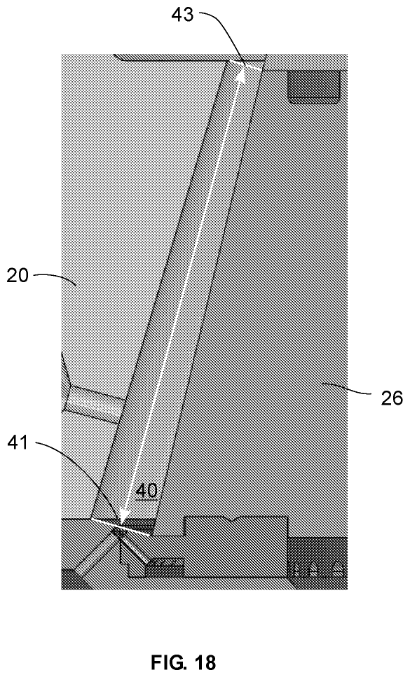

FIG. 6 shows how inner body 26 tapering outer wall 28 and outer body 20 inner wall 24 form a channel between them. Depending on the shape of the inner body 26 outer wall 28 and/or outer body 20 interior wall 24 as shown in FIGS. 6-8, the channel may have an increasing width (FIG. 6), a constant width (FIG. 7), or a decreasing width (FIG. 8). In one example, the outer body opening interior wall tapers to form a smaller proximate upstream perimeter expanding to a larger distal downstream perimeter. In another embodiment, the outer body opening interior wall tapers from a larger proximal upstream perimeter to a smaller distal downstream perimeter. The channel may have a constant width along the flow direction or a variable width along the flow direction. The channel may have a cross sectional area that decreases along the streamwise direction, increases along the streamwise direction, or remains constant along the streamwise direction. In one example, the ratio of the area of the channel at the injection point 41 (A_{ch}) to the area of the channel at the restriction point 43 (A_{I}) may be 0.85 or 1.26. The ratio of the width of the channel at the injection point 41 (Δ_{ch}) to the width of the channel at the restriction point 43 (Δ_{I}) may be 1.67 for a variable channel width or 1.0 for a constant channel width. See FIG. 18. Other ratios are possible.

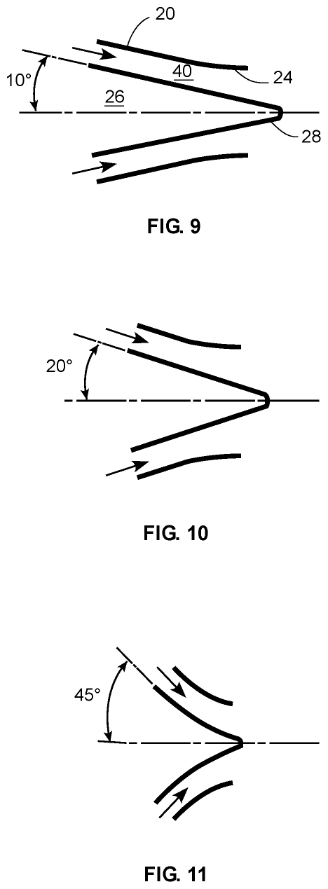

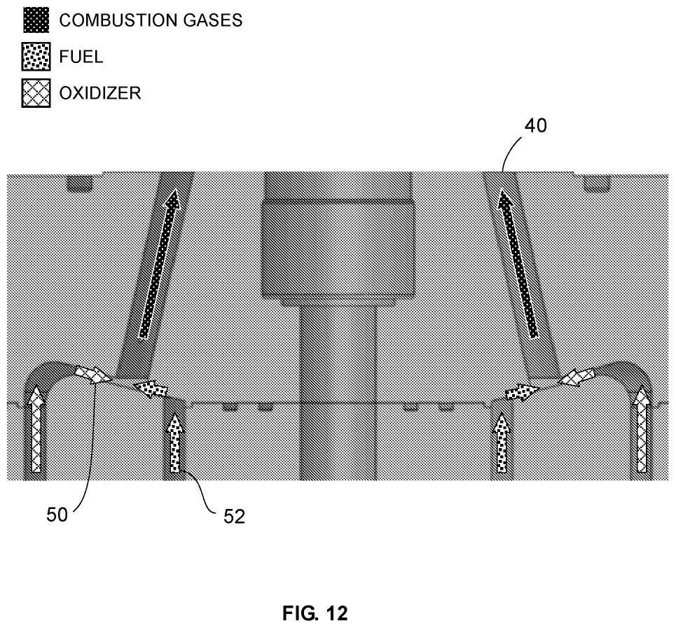

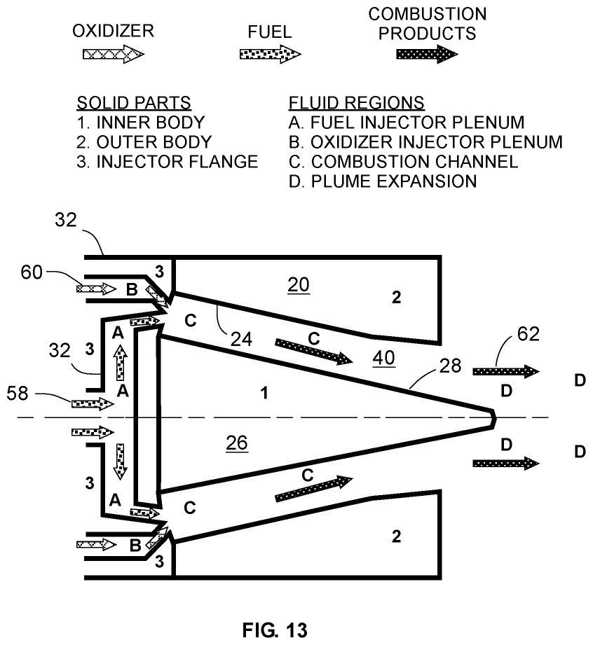

FIGS. 9-11 show inner bodies with a 10°, 20° and 45° cone half angle, respectively. The injector components may be configured to mix an oxidizer and a fuel and to direct a mixture into the combustion channel preferably at an angle corresponding to the angle of the combustion channel. FIG. 12 shown how the injector structure injects an oxidizer at 50 and a fuel at 52 such that the injector face is perpendicular to the combustion channel 40. FIG. 13 shows a design where injector flange 32 directs fuel 58 and an oxidizer 60 into the combustion chamber 40 along the direction of the combustion chamber. Plume expansion region 62 is also shown.

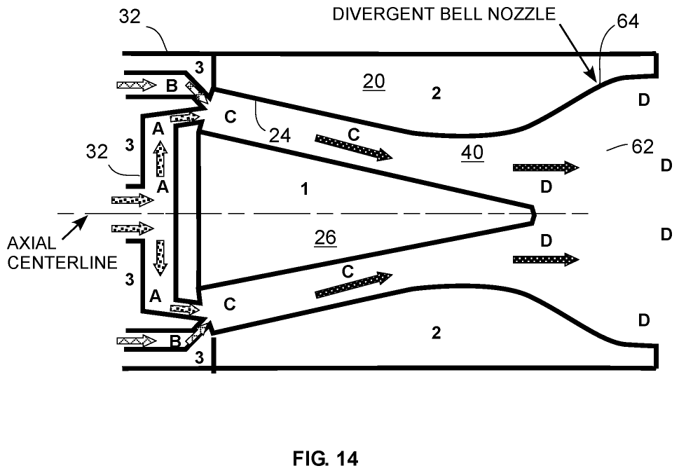

FIG. 14 shows a design with a divergent bell nozzle 64.

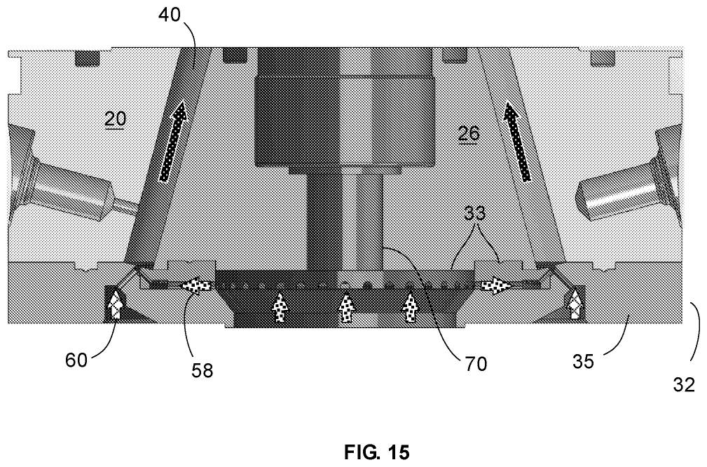

FIG. 15 shows a design where the inner body 26 has a center hole 70 for a fastener that allows the inner body 26 to be coupled to an injector flange 32. FIG. 15 shows an injector flange 32 including two parts, an inner injector part 33 and an outer injector part 35.

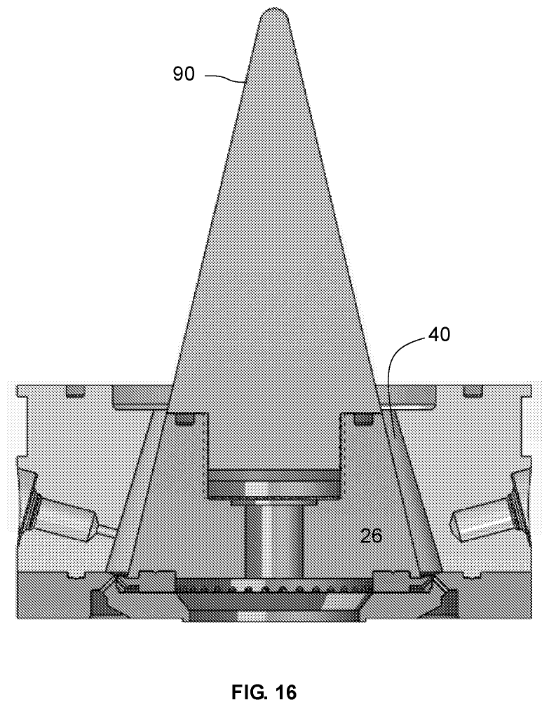

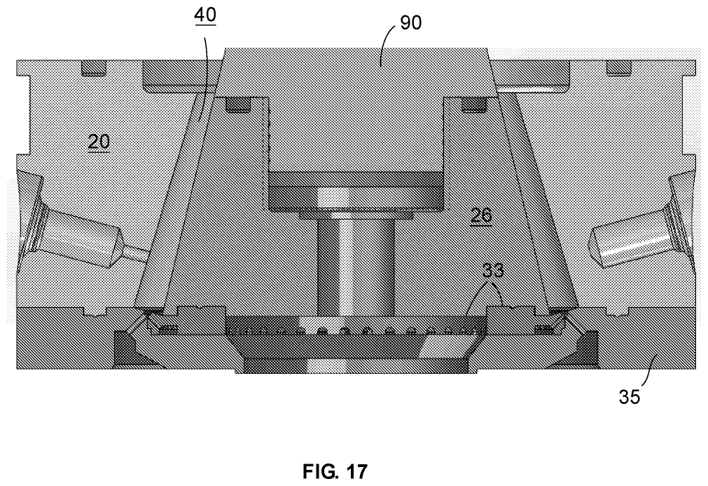

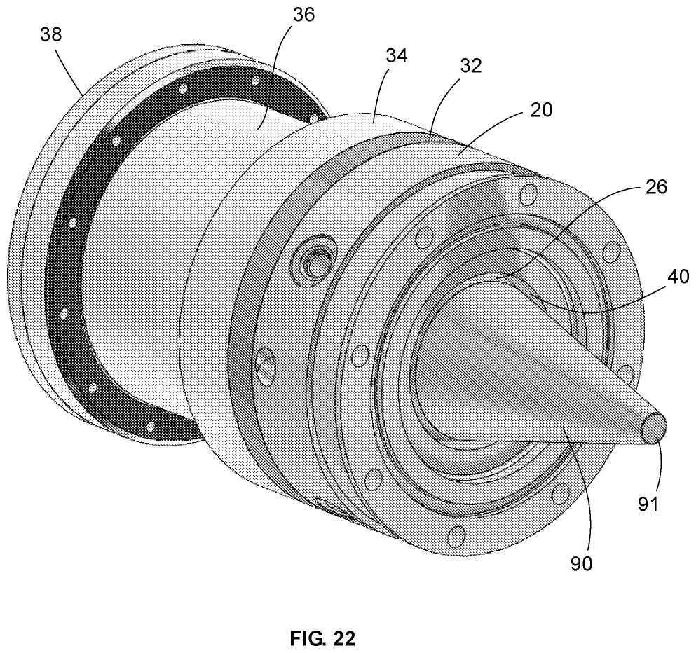

FIGS. 16 and 17 show a design where a cone is added to the distal downstream end of inner body 26 to extend the inner body. For an engine being used at sea level, the inner body cone would come to a point due to ambient pressure. For an engine being used at high altitude (or in space) the cone would be cut off to have a flat end at 91 in FIG. 22 rather than a point. The shorter version with a flat end would be called a “truncated inner body” or “truncated aerospike” or a “truncated plug nozzle”. The cone helps the gases expand more efficiently. FIG. 18 is a detailed view of the design shown in FIG. 17, showing fuel injectors and oxidizer injectors that flow reactants into the detonation channel such that the collective momentum of the reactants is nominally in line with the detonation channel. In FIG. 18, the channel imposes an area restriction by using a conical orientation and also by reducing the width of the channel along the streamwise direction.

The conical channel geometry increases the thrust efficiency, or specific impulse (Iₛₚ), of rotating detonation engines by reducing the severity of turns that occur between the injector and the exhaust plume. The performance improvements achieved by replacing a cylindrical channel with a conical channel outweigh the perceived complexities of a conical detonation path.

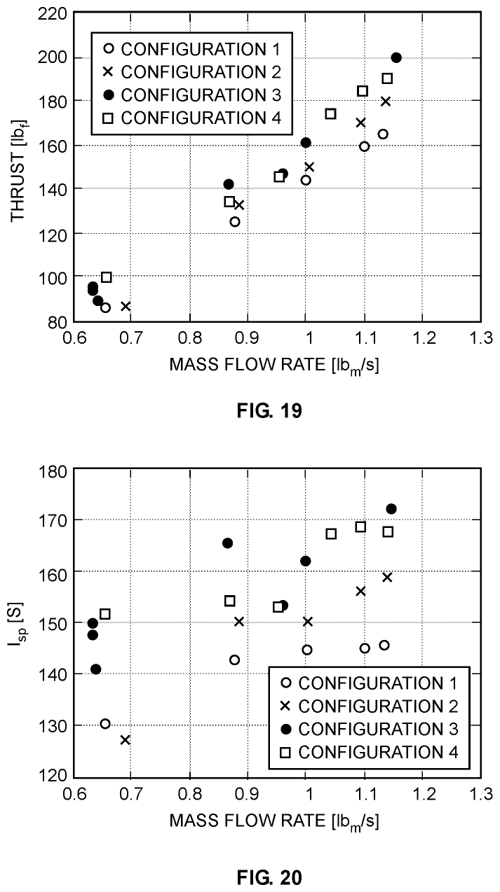

Three conical rotating detonation engines (Configurations 2, 3, and 4) outperformed a cylindrical baseline rotating detonation engine (Configuration 1) with respect to thrust (FIG. 19) and specific impulse (FIG. 20). Specific impulse data was gathered experimentally by hot-firing rotating detonation engines with gaseous oxygen and gaseous methane propellants and measuring propellant mass flow rates and engine thrust. FIG. 20 is a plot of specific impulse (Iₛₚ) in seconds versus total propellant mass flow rate in pounds per second, where a nominal fuel-oxidizer equivalence ratio of 1.1 was used. Specific impulse was measured to be greater for the conical designs than for the cylindrical baseline.

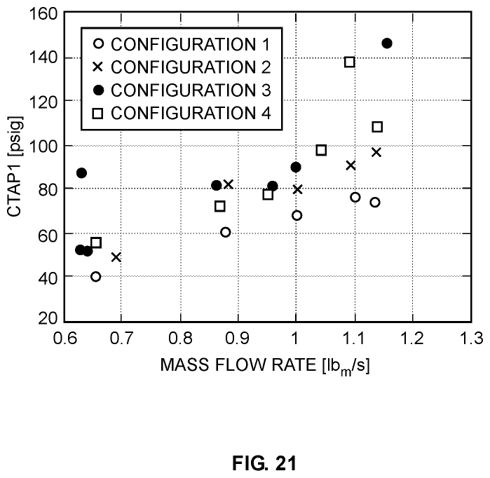

For the same engine firings plotted in FIG. 20, the pressure in the detonation channel was measured using capillary tube attenuated pressure (CTAP) measurements. The pressure ports for CTAP measurements were located at a distance 0.30″ downstream from the injector face. CTAP values are plotted in FIG. 21. This plot shows an increase in average channel pressure created when the cylindrical channel is replaced with a conical channel.

Of particular importance in FIG. 21 are the results for Configuration 2, which used the conical channel design with an area expansion. An area expansion reduces flow restrictions and is commonly expected to result in lower CTAP values. Despite an area expansion, Configuration 2 resulted in higher CTAP values than the cylindrical baseline design (Configuration 1). This benefit resulted from the conical channel design, where the shock wave associated by the detonation wave is oblique to a slightly concave wall. In the case of a cylindrical channel, the wall is perpendicular to the path of the detonation and shock wave, not concave. By operating with the detonation shock wave oblique to a concave wall, the conical detonation channel requires that the flow behind the shock must turn in order to follow the wall. This slight confinement of flow behind the shock was shown to yield higher combustion performance in theoretical studies of detonations following a concave wall in Paxson (2020).

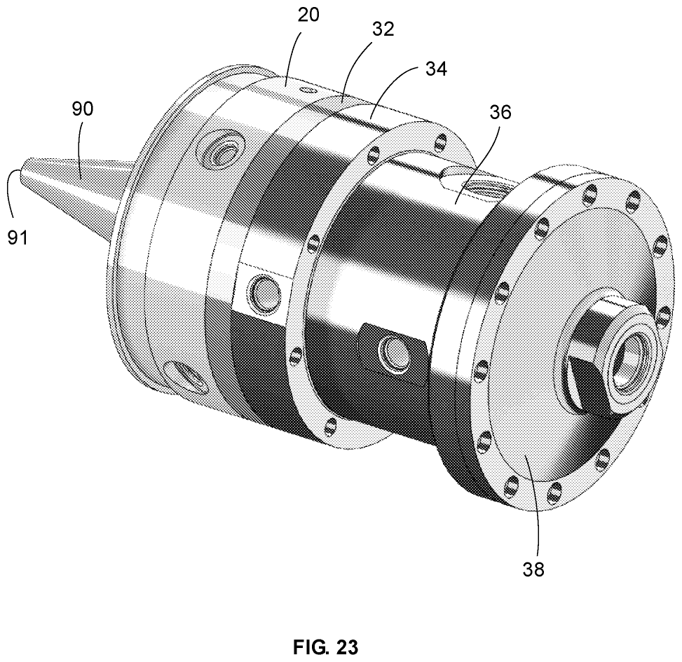

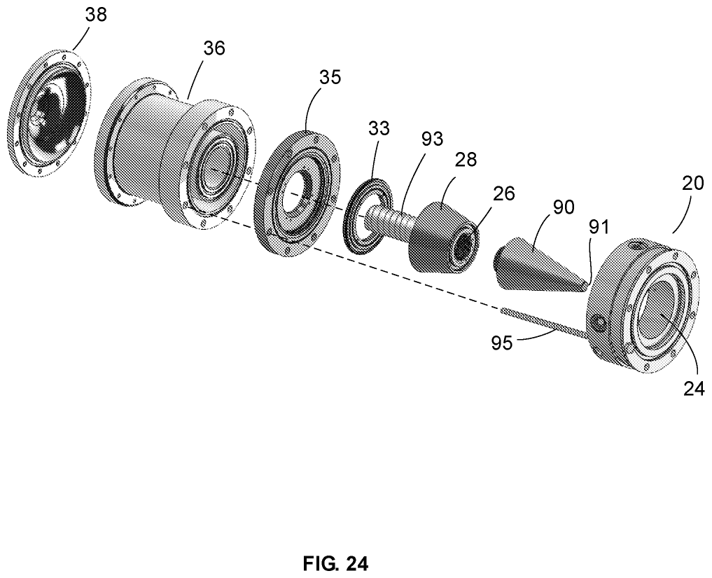

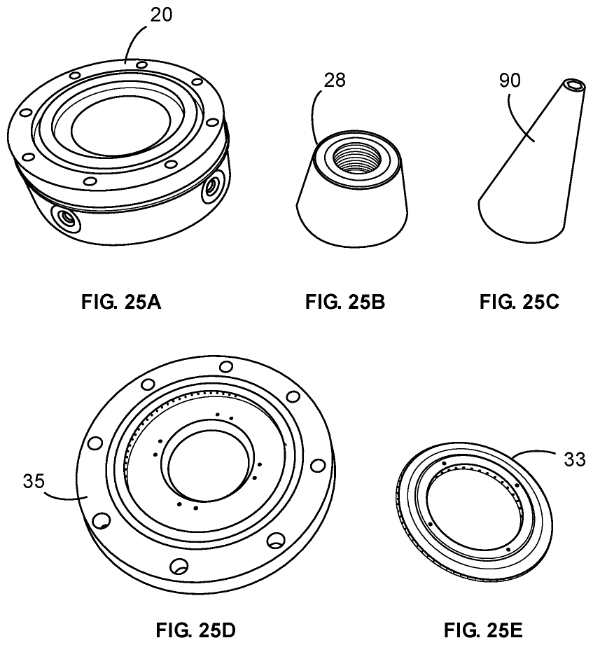

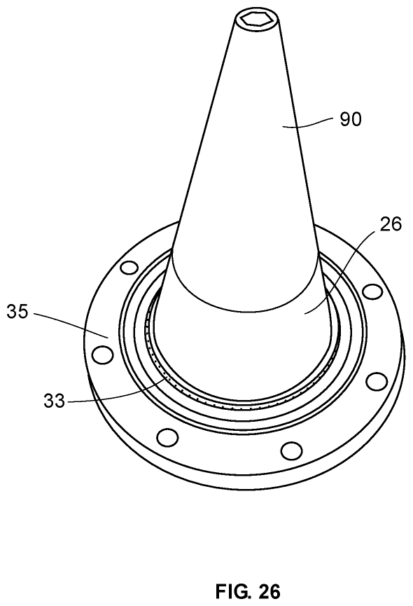

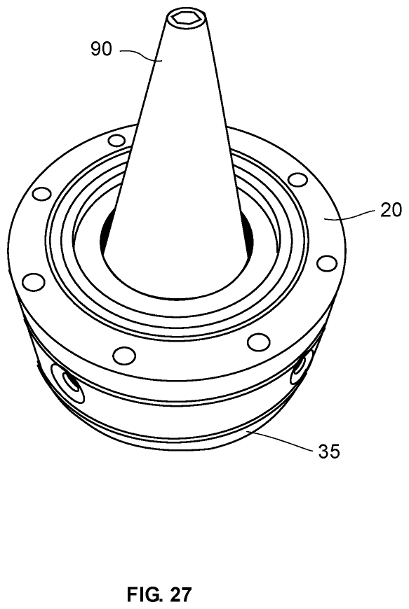

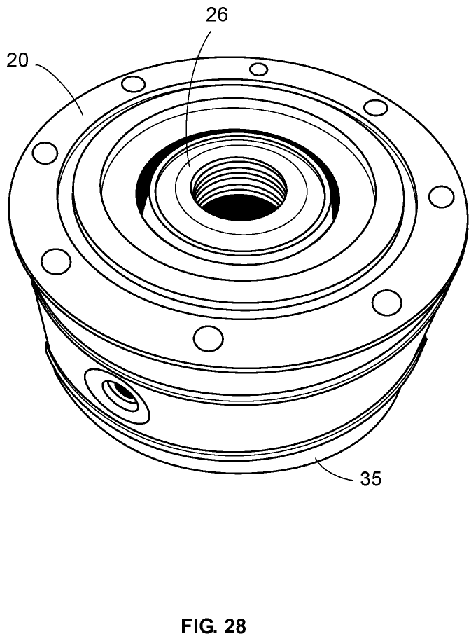

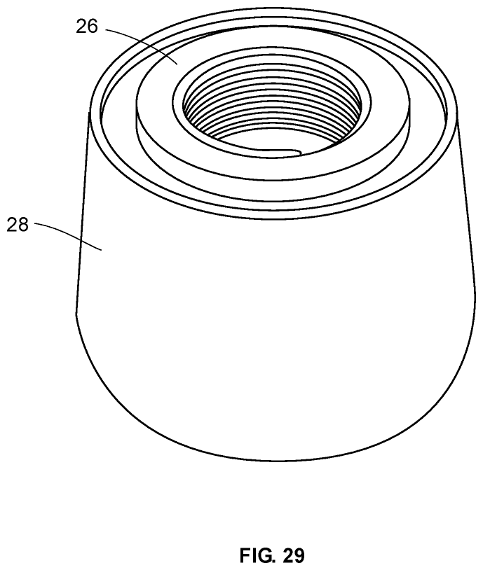

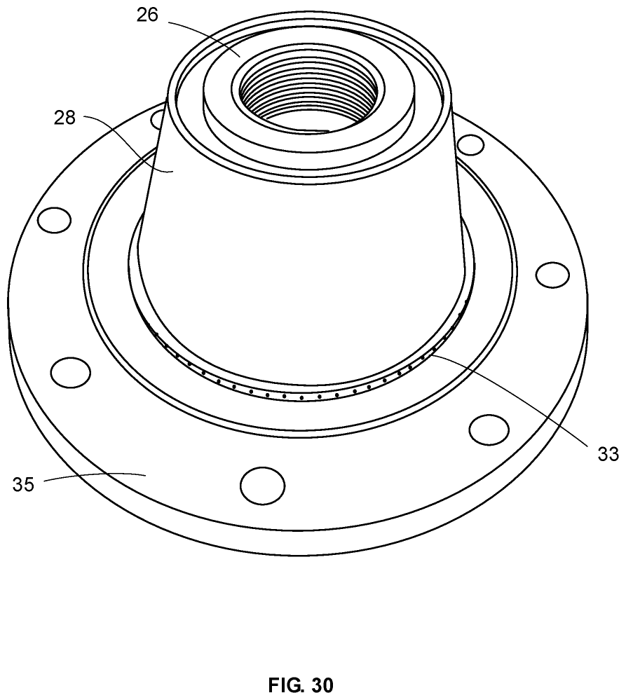

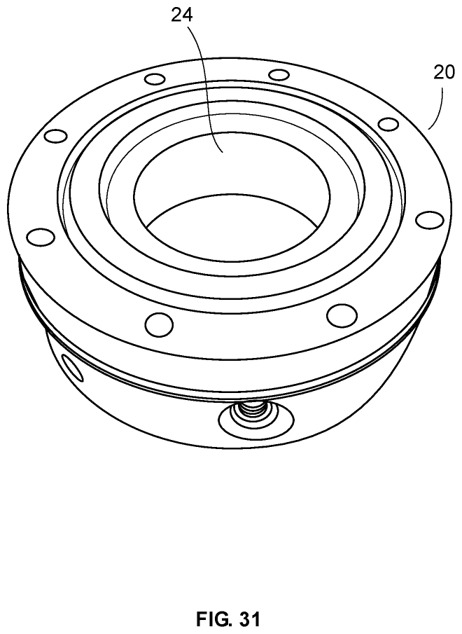

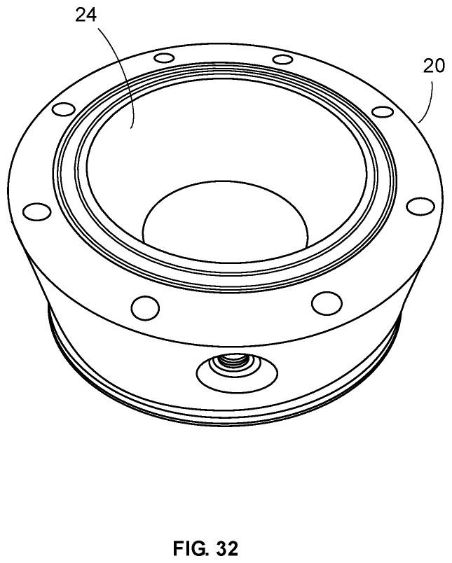

FIGS. 22-34 show additional features. FIG. 24 shows how a fastener 93 secured into the inner body extends through the injector components 33, 35 and is secured withing intake 36. Similarly, fasteners such as fastener 95 extends upstream from outer body 26, through injector flange outer piece 35, and is secured to intake 36.

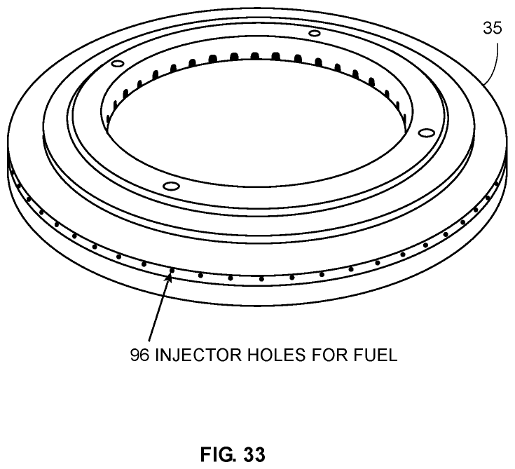

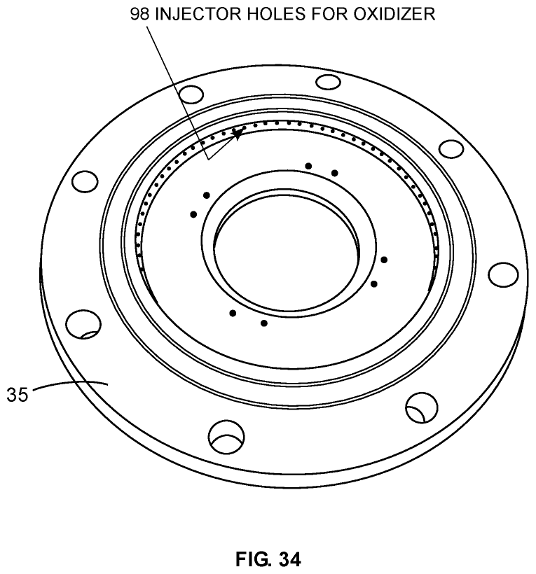

FIGS. 33-34 depict injector inner flange 33 with peripheral outer fuel injector holes 96 and injector outer flange 35 with inner peripheral oxidizer injector holes 98. Holes 96 and holes 98 are oriented, when inner flange 33 is fitted within outer flange 35, to mix the fuel and oxidizer at the proximal upstream region of the detonation channel and to direct the mixture into and along the direction of the channel.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A rotating detonation engine comprising:
an outer body with an opening therethrough having an interior wall;
an inner body received in the outer body opening and with an outer wall tapering in the flow direction of the engine and spaced from the outer body opening interior wall defining a non-cylindrical improved efficiency detonation channel between the inner body outer wall and outer body opening interior wall; and
means for retaining the inner body within the outer body.

2. The engine of claim 1 in which the inner body outer wall tapers from a larger proximal upstream perimeter to a smaller distal downstream perimeter.

3. The engine of claim 1 in which the inner body outer wall forms a cone.

4. The engine of claim 1 in which the outer body opening interior wall tapers.

5. The engine of claim 4 in which the outer body opening interior wall expands from a smaller proximal upstream perimeter to a larger distal downstream perimeter.

6. The engine of claim 4 in which the outer body opening interior wall tapers from a larger proximal upstream perimeter to a smaller distal downstream perimeter.

7. The engine of claim 1 in which the detonation channel has a constant width along the flow direction.

8. The engine of claim 1 in which the detonation channel has a variable width along the flow direction.

9. The engine of claim 1 in which the detonation channel has a cross sectional area that decreases along the streamwise direction, increases along the streamwise direction, or remains constant along the streamwise direction.

10. The engine of claim 1 further including an injector configured to mix an oxidizer and fuel and to direct the mixture into the detonation channel.

11. The engine of claim 10 in which the injector is configured to direct the mixture at an angle corresponding to the angle of the detonation channel.

12. The engine of claim 1 in which the means for retaining includes at least one fastener coupling the inner body to an injector structure and one or more fasteners coupling the outer body to an injector structure.

13. The engine of claim 1 in which the inner body distal downstream end is fitted with a cone structure.

14. The engine of claim 13 in which the cone structure has a truncated, flat end.

15. The engine of claim 10 in which the injector includes an inner injection flange including outer peripheral fuel injector holes.

16. The engine of claim 15 further including an outer injection flange receiving the inner injection flange therein and including inner peripheral oxidizer injection holes.

17. The engine of claim 16 in which the outer fuel injection holes and the inner oxidizer injection holes are configured to mix a fuel and an oxidizer at the proximal upstream region of the detonation channel and to direct the mixture into and along the direction of the channel.

18. A rotating detonation engine comprising:
an outer body with an opening therethrough having an interior wall;
an inner body received in the outer body opening and with an outer wall tapering in the flow direction of the engine and spaced from the outer body opening interior wall defining a non-cylindrical improved efficiency detonation channel between the inner body outer wall and outer body opening interior wall;
an injector assembly including peripheral fuel injector slot or holes and peripheral oxidizer injector slot or holes configured to mix a fuel and an oxidizer and to direct the mixture into and along the direction of the detonation channel; and
the inner body and the outer body secured to the injector assembly to space the outer body opening interior wall from the inner body outer wall.

19. The engine of claim 18 in which the inner body outer wall tapers from a larger proximal upstream perimeter to a smaller distal downstream perimeter.

20. The engine of claim 18 in which the inner body outer wall forms a cone.

21. The engine of claim 18 in which the outer body opening interior wall tapers.

22. The engine of claim 21 in which the outer body opening interior wall expands from a smaller proximal upstream perimeter to a larger distal downstream perimeter.

23. The engine of claim 21 in which the outer body opening interior wall tapers from a larger proximal upstream perimeter to a smaller distal downstream perimeter.

24. The engine of claim 18 in which the detonation channel has a constant width along the flow direction.

25. The engine of claim 18 in which the detonation channel has a variable width along the flow direction.

26. The engine of claim 18 in which the detonation channel has a cross sectional area that decreases along the streamwise direction, increases along the streamwise direction, or remains constant along the streamwise direction.

27. The engine of claim 18 in which the inner body distal downstream end is fitted with a cone structure.

28. The engine of claim 27 in which the inner body distal downstream end is fitted with a cone structure that has a truncated, flat end.
